(19) United States
(12) Patent Application Publication
(10) Pub. No.: US 2008/0219287 A1
(43) Pub. Date: Sep. 11, 2008

(54) DEVICE FOR DETERMINING A NUMBER OF DATA PACKETS

(76) Inventors: Martin Krueger, Muenchen (DE); Roland Gruber, Sauerlach (DE); Andre Zorn, Muenchen (DE)

Correspondence Address: Thomas G. Eschweiler, Esq.;Eschweiler & Associates, LLC, 629 Euclid Avenue, Suite 1000, Cleveland, OH, 44114, US

(21) Appl. No.: 11/777,855

(22) Filed: Jul. 13, 2007

(30) Foreign Application Priority Data
Jul. 14, 2006 (DE) 10 2006 032 729.2

(51) Int. Cl. H04L 12/43

(52) U.S. Cl. 370/458

(57) ABSTRACT

The invention is directed to a device for determining a number of data packets which are to be converted into a coded sequence with a predetermined number K_{N} of bits by a coder. The device determines the number of data packets in such a manner that a difference between the resultant code rate R_{N}, resulting from a conversion of the number of data packets into the coded sequence, and a reference code rate R₁ does not exceed a predetermined threshold value.

### REFERENCE TO RELATED APPLICATIONS

This application claims the benefit of the priority date of German application DE 10 2006 032 729.2-31, filed on Jul. 14, 2006, the contents of which are herein incorporated by reference in their entirety.

### FIELD OF THE INVENTION

The present invention relates to the determination of a number of data packets for coding proposes, for example.

### BACKGROUND OF THE INVENTION

When data are transmitted, via, e.g. EGPRS (Enhanced General Racist Radio Service), they are first split into data packets. Each data packet or each pair of data packets, respectively, is channel-coded in accordance with one of nine possible modulation coding schemes (MCS) and transmitted in distributed fashion over four TDMA (time division multiple access) frames. One TDMA frame lasts 4.6 ms, only one of eight time slots of length 577 μs being occupied for one data packet allocated to one TDMA frame.

To increase the throughput, time slots can be bundled (multislot allocation), and burst mapping can also take place with an allocation of only one time slot. In this process, N time slots are allocated so that, for example, N data packets or pairs of data packets are transmitted via 4 TDMA frames. The number of allocated time slots is selected dynamically via the network forming the basis for time data transmission and is signalled to a mobile station directly before the respective data packet is sent out to the base station. In contrast, the modulation coding scheme used is agreed earlier so that the data packets can be split in advance. When a coding scheme used by a coder for data coding has been specified in accordance with the channel quality, the data rate is proportional to the number of time slots N allocated.

In the case of a number of adjacent time slots, the time slot bundle (burst) contains a number of training sequences and known bits at the beginning and at the end of each time slot. However, the supplementary information can be provided only once for the entire burst so that only one training sequence occurs, and the start and end bits occur only once. Since, for example, only one training sequence is transmitted with a burst consisting, for example, of four time slots, bits become free which can be used, for example, for coded bits.

### BRIEF DESCRIPTION OF THE DRAWINGS

Further illustrative embodiments of the present invention will be explained with reference to the attached figures, in which:

FIG. 1a shows an arrangement of a concept according to one embodiment of the invention;

FIG. 1b shows an arrangement in according with one embodiment of the invention;

FIGS. 2a-e show tables for selecting the coding scheme to be used; and

FIGS. 3a, 3b show a diagrammatic representation of the burst.

### DETAILED DESCRIPTION OF THE INVENTION

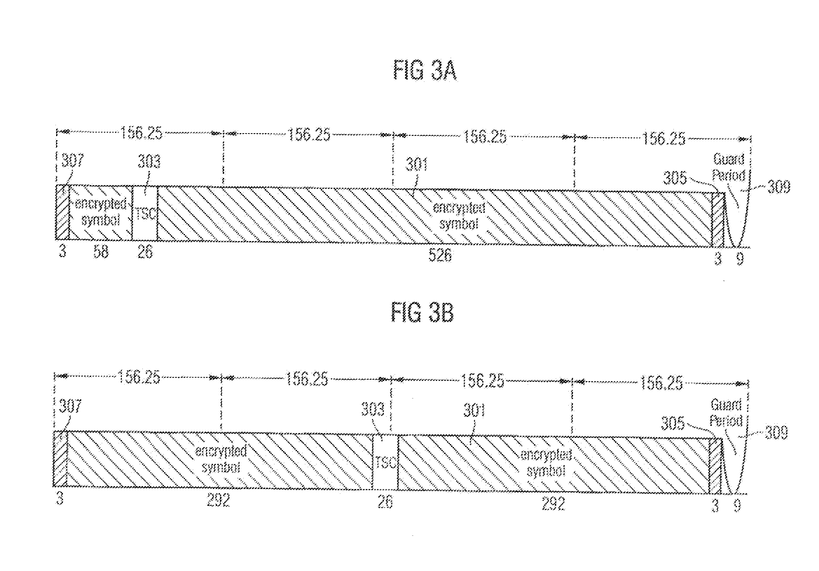

FIG. 3a shows a burst consisting of four time slots of length 156.25 or 577 μs symbols with an encrypted data field 301 and a training sequence 303 (TSC) arranged in a first slot. At the beginning and at the end of the burst, known bits 305 and 307 are in each case arranged. Furthermore, a guard period 309 can be provided.

FIG. 3b shows a burst formed of four bundled time slots in which the training sequence 303 is arranged in the centre of the newly produced time slot. The periods of the respective symbol sections can be found in FIGS. 3a and 3b.

The coded bits, which are arranged, for example, in data field 301, contain channel-coded data bits, on the one hand, and the channel-coded information about the channel coding of the data bits (channel-coded header bits), on the other hand. The information about the channel coding of the data bits is currently transmitted four times in the case of a burst of four time slots.

The bits becoming free can be used as fellows:
option 1: increasing the data rate while at the same time retaining redundancy;
option 2: increasing the redundancy in the channel coding of the data bits while at the same time retaining the data rate; and
option 3: simultaneously increasing the data rate and the redundancy.

An increase in data rate means that the data rate increases superproportionally to the number of allocated time slots N.

According to the known concepts, the size of the data packets or of the pairs of data packets is dependent on the number of allocated time slots. The result is that the segmenting into data packets can only take place after a dynamic allocation. This is a great burden for the implementation of the protocol stack. The link adaptation of the EGPRS RLC protocol also requires that the data unit sizes provided are maintained. The sizes provided form three families with in each case one common base of 22, 28 and 37 octets (i.e. 176, 224 and 296 bits, respectively). This base must not be departed from so that retransmissions of the individual RLC blocks which become necessary later can be carried out. Thus, a dynamic allocation with allocation-dependent packet size would not even allow link adaptation.

The invention is directed to a method of determining the number of data packets to be coded by a coder, wherein dynamic multislot allocation can be carried out in a simple manner.

In one embodiment, the present invention comprises determining the number of data packets to be coded, taking into account a later multislot allocation, when jointly considering the number of data packets to be determined and the code rate resulting during the coding of the number of data packets by using a coding scheme. An optimization task with two variables, namely the number of data packets and the resultant code rate, resulting from this objective, can be solved by taking into consideration a boundary condition. This boundary condition can be, for example, a threshold value which, for example, cannot be exceeded by the resultant code rate or below which the resultant code rate cannot drop.

The invention is further directed to a device for determining a number of data packets which are to be converted into a coded sequence with a predetermined number of bits by a coder, wherein a data packet has a multiplicity of bits (for example two or more bits). The device for determining the number of data packets comprises a calculating device configured to arrange for determining the number of data packets in such a manner that a difference between the resultant code rate, resulting from a conversion of the number of data packets into the coded sequence by using a coding scheme, and a reference code rate does not exceed a predetermined threshold value. This threshold value in one embodiment is 0, and in another embodiment is a threshold value interval between 0 and 10% of the reference code rate.

If, in one embodiment, each data packet has an identical number of bits, the number of data packets determines the total number of bits to be coded in a data sequence.

According to one embodiment, the coded sequence or a sequence which is derived from the coded sequence can be divided into a multiplicity of time slots of a burst, wherein, for example, for transmitting the coded sequence or the derivable sequence, for example, a number N of dynamically allocated end aggregated time slots is used, e.g. per TDMA frame. The multiplicity of time slots is combined, in one embodiment, to form one frame, needing a single training sequence (TSC). This results in a saving of bits because in a separate transmission of a number of time slots, one training sequence would otherwise have to be provided per time slot. The coded sequence or the derivable sequence (for example due to interleaving) can be combined, in one embodiment, to form one burst which has a number of time slots as is shown in FIGS. 3a and 3b. In this case, the reference code rate is the code rate which results from an allocation of the coded sequence or the derivable sequence to a single time slot. This reference code rate is thus the maximum code rate achievable by using a coding scheme.

In one embodiment the number of data packets is preferably determined in such a manner that the difference between the code rate resulting from the coding of the number of data packets (the ratio of she number of uncoded bits to the number of coded bits) and the reference code rate is lower than the predetermined threshold value or equal to the predetermined threshold value. The predetermined threshold value in one embodiment is less than the reference code rate and greater than or equal to 0.

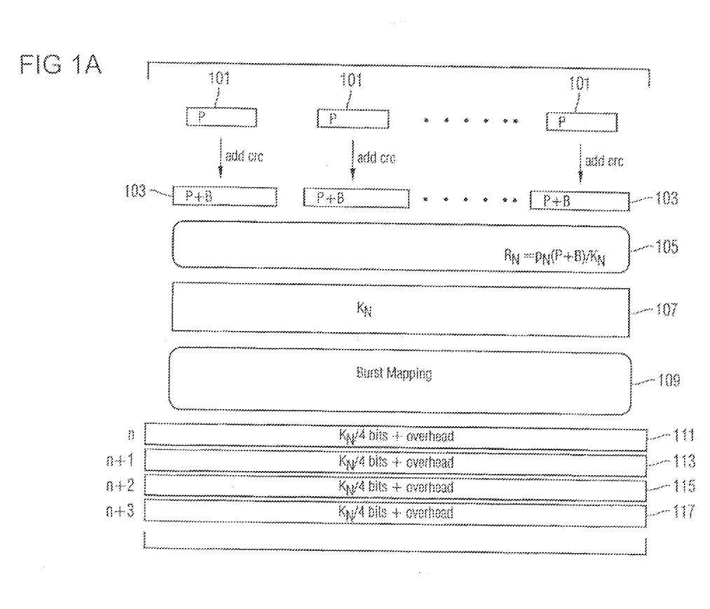

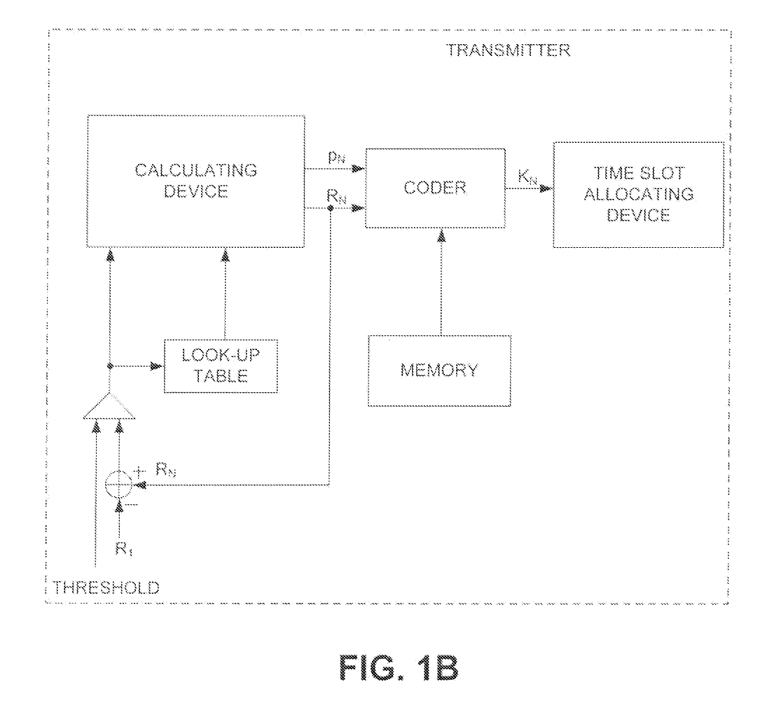

According to one embodiment, the calculating device is configured to determine the number of data packets iteratively, as illustrated in FIG. 1b. Since the number of data packets specifies the length of the data sequence to be coded, a formula for the code rate is used. During the iterative determination of the number of data packets, it is possible to start, for example, with two data packets or one data packet in a first iteration step. The number of bits of the coded sequence depends in one embodiment on the coding scheme to be used and remains unchanged during the iteration. The code rate determined in the first iteration step is compared, in one embodiment, with the reference code rate R₁, where it is established whether the predetermined threshold value is exceeded or not exceeded. If the threshold value is exceeded, the number of data packets is increased by one increment, for example by 1 and the code rate is recalculated and compared with the reference code rate. The iteration is continued as described above until a number of data packets p_{N} has been determined for which the difference between the reference code rate and the predetermined threshold value which is not exceeded by the resultant code rate becomes, e.g. minimum with reference to the code rates already calculated. The iteration can be terminated, in one embodiment, if the difference becomes greater again from a particular number of data packets onward.

According to one embodiment, the coded sequence is interleaved by an interleaver.

In one embodiment the calculating device is configured to calculate the number of data packets p_{N} on the basis of the following formula:

p_{N}=argmax{p_{N} ε {p₁, p₁+1, p₁+2, . . . }|R_{N}(p_{N})=p_{N}(P_{N}+B)/K_{N}≦B₁}

where P_{N} is the number of data bits per data packet, B is the number of additional bits, for example CRC bits, R_{N} is the resultant code rate which, according to the invention, depends on the number of data packets p_{N}. K_{N} designates the number of bits of the coded sequence or, respectively, a sequence which can be derived from this sequence (e.g., by the interleaving). R₁ is the reference code rate.

According to a further embodiment, the calculating device is configured to determine the number of data packets p_{N} by using the following formula:

p_{N}=argmax{p_{N} ε (p₁, p₁+1, p₁+2, . . . )|R_{N}(p_{N})=p_{N}(P_{N}+B)/K_{N}≦R₁+δR}.

where δR is, in one embodiment, a predetermined threshold value which should not be exceeded with a difference between R_{N} and R₁. This threshold value can be, for example, 10% of R₁.

In another embodiment the present invention is directed to a transmitter device which has the device configured to determine the number of data packets according to the invention, as illustrated in FIG. 1b. The transmitter device also comprises a coder configured to convert the number of data packets into a coded sequence with a number of bits K_{N} by using a coding scheme with the resultant code rate. The coding scheme can be, in one embodiment, a Reed Solomon coding or a convolutional coding, wherein puncturing can be optionally performed.

The coding schemes to be used can be provided, in one embodiment, in the form of tables in a memory element and depend, for example, on the number of data packets, and/or on thee number of bits per data packet, and/or on the number of bits of the coded sequence, and/or on the resultant code rate and/or in dependence on the number of time slots over which the coded sequence or a sequence which can be derived from the coded sequence can be divided. Furthermore, the table or the tables can contain in one embodiment the puncturing scheme of a puncturing unit which is comprised by the transmitter device.

According to a further embodiment, the transmitter device comprises a time slot allocating device which is configured to divide the coded sequence or a sequence which can be derived from the coded sequence (for example due to the interleaving) into a number of part-sequences and allocating each part-sequence to a time slot. In this process, the time slots can be bundled and combined to form a common burst.

According to a further embodiment, the transmitter device comprises a transmitter configured to send out the coded sequence or the sequence which can be derived from the coded sequence in a multiplicity of time slots which, in one embodiment, are bundled, wherein a part-sequence of the coded sequence or of the derivable sequence is allocated to one time slot.

FIG. 1a illustrates the arrangement according to one embodiment of the invention in accordance with a TDMA transmission. In this transmission, a number of sequences 101 with in each case P data bits is provided for the transmission. The number P of data bits is not a function of the allocated slots in one embodiment. Each sequence can be coded, for example, as a result of which, for example, B CRC (cyclic redundancy check) bits are in each case added. From the number of data sequences 101, a number of data packets 101 is thus produced, one data packet 103 in each case resulting tram a data sequence 101. The number of data packets 103 is coded in step 105, each data packet being coded separately or all packets being coded jointly. In one embodiment the coding comprises convolutional coding wherein puncturing can be subsequently performed. Alternatively, however, other types of coding may be employed and all such alternatives are contemplated as falling within the scope of the invention. The bits can be optionally interleaved before and/or after the coding, for example by using an interleaver.

In one embodiment the coding is performed by a coder with the code rate:

P_{N}=p_{N}(P+B)/K_{N}

where R_{N} designates the resultant code rate, p_{N} designates the number of data packets which is determined in accordance with the present invention, P is the number of data bits in the respective sequence 101, B is the number of optional redundancy bits and K_{N} is a predetermined number of bits of the coded data sequence output by the coder. The redundancy bits can also have parity bits (block sequence check).

In one embodiment the calculating device determines, on the basis or the above equation, the number of data packets for which, using a coding scheme, a resultant code rate is produced which, for example, is not greater than a predetermined threshold value or, respectively, which differs from a reference code rate by a predetermined threshold value at a maximum.

The coded sequence of length K_{N} is optionally interleaved by using an interleaver at 107. The K_{N} interleaved bits form the basis for the burst mapping that follows at 109, a burst mapping packet being generated in each case for an allocated time slot specified in a table. After the burst mapping 109, the bits and, additionally, the overhead are distributed to the TDMA frames 111, 113, 115 and 117. The TDMA frame 111 can be, for example, an nth frame which has K_{N}4 bits and one overhead. Frame 113 is, for example, a TDMA frame with frame number n+1 which has also been assigned, for example, K_{N}/4 bits and an overhead. The frames 115 and 117 are, for example, frames with indices n+2 and n+3 which have been allocated in each case K_{N}/4 bits and overhead.

According to one embodiment of the invention, N dynamically allocated and aggregated time slots are generated per TDMA frame. The overhead can comprise, for example, the training sequence (TS), the tail bits, the guard period or coded and interleaved header bits. According en one embodiment, the number of bits per data packet P_{N}=P, p_{N}, R_{N} is a function of the allocated slots and of the coding scheme. The TS field can also comprise parity bits (block sequence check).

According to one embodiment of the invention, the size of the data packets is not changed in the case of an allocation of a number of time slots. The bits becoming free are filled with additional data packets and the bits which can thus not be used are for more redundancy. This measure increases the data rate since the file can still be segmented into data segments in advance before the dynamic allocation. Furthermore, link adaptation of the RLC protocol is possible via the procedures already standardized, without additional expenditure.

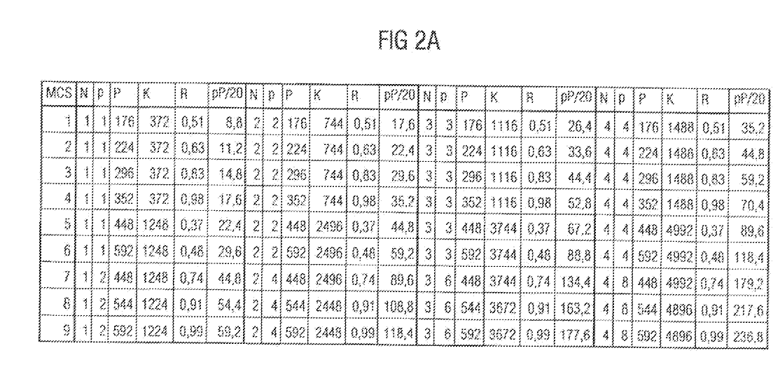

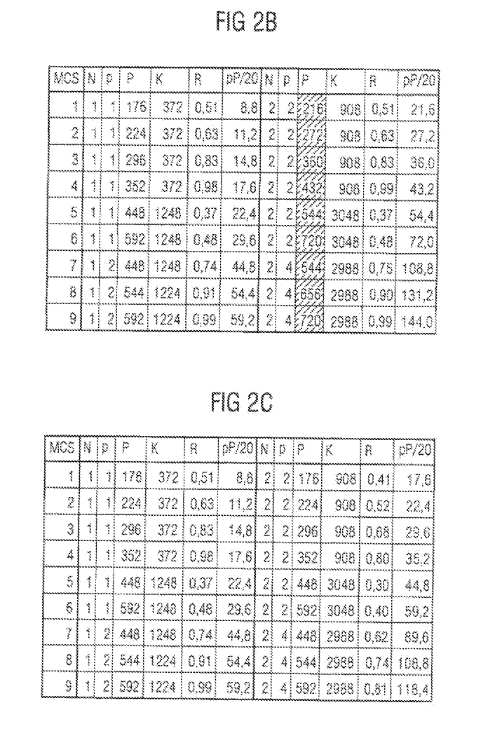

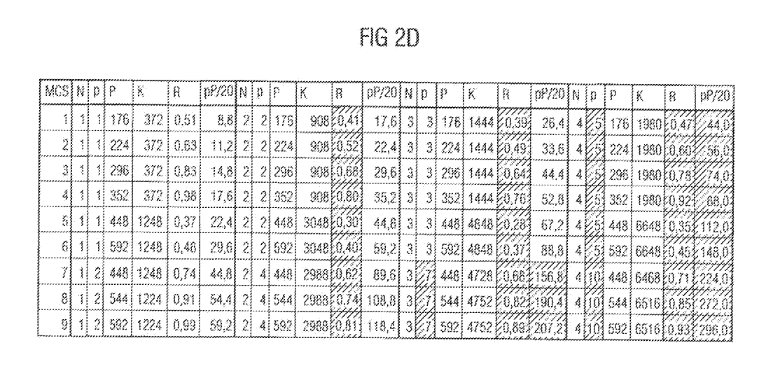

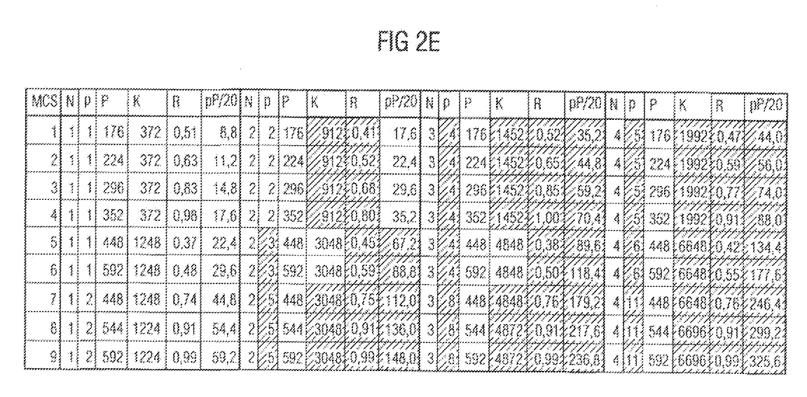

In FIGS. 2a to 2e, the parameters p, P, K, R and the resultant data rate pP/20 in kbit/sec are combined, for example, for 9 EGPRS modulation coding schemes MCS-1 to MCS-9 and for various allocations N=1, 2, 3, 4. For N=1, these parameters are equal in all figures since no advantage can be achieved by time slot aggregation here.

FIG. 2a shoos the parameters as predetermined by the 3GPP standard 45.003. There is no time slot aggregation.

FIGS. 2b and 2c show the parameters according to two proposals which were published in the 3GPP document GP-060640 (N=1 and N=2 in this case).

FIGS. 2d and 2e show the parameters according to the invention. The time slot aggregation is now utilized for increasing the data rate without disadvantageous implication for the protocol stack and in conformity with link adaptation.

As provided in the 3GPP standard, the selection of the coding scheme MCS-1 to 9 and the allocation of the time slots is in all cases performed by the network in dependence on the loading on the cell and the quality of the channel.

Although specific embodiments hove been illustrated and described herein, it will be appreciated by those of ordinary skill in the art, that any arrangement which is calculated to achieve the same purpose may be substituted for the specific embodiments shown. It is to be understood, that the above description is intended to be illustrative and not restrictive. This application is intended to cover any adaptations or variations of the invention. Combinations of the above embodiments and many other embodiments will be apparent to those of skill in the art upon reading and understanding the above description. The scope of the invention includes any ether embodiments and applications in which the above structures and methods may be used. The scope of the invention should, therefore, be determined with reference to the appended claims along with the scope of equivalents to which such claims are entitled.

It is emphasized that the Abstract is provided to comply with 37 C.F.R. section 1.72(b) requiring an abstract that will allow the reader to quickly ascertain the nature and gist of the technical disclosure. It is submitted with the understanding, that it will not be used to interpret or limit the scope or meaning of the claims.

1. A device configured to determine a number of data packets to be converted into a coded sequence with a predetermined number K_{N} of bits by a coder, comprising:
a calculating device configured to determine the number of data packets so that a difference between a resultant code rate R_{N}, resulting from a conversion of the determined number of data packets into the coded sequence, and a reference code rate R₁ does not exceed a predetermined threshold value.

2. The device of claim 1, wherein each data packet has an identical number of bits.

3. The device of claim 1, further comprising a time slot allocating device, wherein the coded sequence or a sequence derived from the coded sequence is divided by the time slot allocating device into a plurality of time slots, and wherein the reference node rate R₁ is the code rate that results from an allocation of the coded sequence or the derivable sequence to a single time slot.

4. The device of claim 1, wherein the predetermined threshold value is less than the reference code rate R₁.

5. The device of claim 1, wherein the calculating device is further configured to determine the number of data packets iteratively or by using a look-up table.

6. The device of claim 1, further comprising an interleaver configured to interleave the coded sequence.

7. The device of claim 1, wherein the calculating device is configured to determine the number of data packets p_{N} on the basis of the formula
p_{N}=argmax(p_{N} ε {p₁, p₁+1, p₁+2, . . . }|R_{N}(p_{N})=p_{N}(P_{N}+B)/K_{N}≦R₁)
p_{N}=argmax(p_{N} ε {p₁, p₁+1, p₁+2, . . . }|R_{N}(p_{N})=p_{N}(P_{N}+B)/K_{N}≦R₁+δR)
where P_{N} is the number of data bits per data packet, where B is the number of redundancy bits, where K_{N} is the number of bits of the coded sequence, where R_{N} the resultant code rate, where R₁ is the reference code rate and where δR is the predetermined threshold value.

8. A transmitter device, comprising:
a calculating device configured to determine the number of data packets so that a difference between a resultant code rate R_{N}p, resulting from a conversion of the determined number of data packets into the coded sequence, and a reference code rate R₁ does not exceed a predetermined threshold value; and
a coder configured to convert the determined number of data packets into a coded sequence with a number of bits K_{N} by using a coding scheme with the resultant code rate R_{N}.

9. The transmitter device of claim 8, further comprising a memory element configured to store a plurality of coding schemes based on the number of data packets, the number of bits per data packet, the number or bits of the coded sequence, the resultant code rate, or the number of time slots over which the coded sequence or a sequence which can be derived from the coded sequence is divided.

10. The transmitter device of claim 8, further comprising a puncturing unit configured to puncture the coded sequence.

11. The transmitter device of claim 8, further comprising a time slot allocating device configured to divide the coded sequence or a sequence derived from the coded sequence into a number of part-sequences, and allocate each part-sequence to a time slot.

12. The transmitter device of claim 8, further comprising a transmitter configured to send out the coded sequence or a sequence derived from the coded sequence in a plurality of time slots, wherein a part-sequence of the coded sequence or of the derivable sequence is allocated to one time slot.

13. A method for determining a number of data packets to be converted into a coded sequence with a predetermined number K_{N} of bits by a coder, comprising:
determining the number of data packets so that a difference between a resultant code rate P_{N}, resulting from a conversion of the determined number of data packets into the coded sequence, and a reference code rate R₁ does not exceed a predetermined threshold value.

14. The method of claim 13, further comprising converting the number of data packets into a coded sequence with a number of bits by using a coding scheme with the resultant code rate R_{N}.

15. The method of claim 13, further comprising dividing the coded sequence or s sequence derived from the coded sequence to a plurality of time slots.

16. The method of claim 15, wherein the reference code rate R₁ is a value that results from an allocation of the coded sequence or the device sequence to a single time slot.

17. The method of claim 13, wherein the method comprises determining the number of data packets using the difference and the predetermined threshold value in an iterative fashion.

18. The method of claim 13, wherein the number of data packets p_{N} is determined according to:
p_{N}=argmax(p_{N} ε {p₁, p₁+1, p₁+2, . . . }|R_{N}(p_{N})=p_{N}(P_{N}+B)/K_{N}≦R₁)
or
p_{N}=argmax(p_{N} ε {p₁, p₁+1, p₁+2, . . . }|R_{N}(p_{N})=p_{N}(P_{N}+B)/K_{N}≦R₁+δR)
where P_{N} is the number of data bits per data packet, where B is the number of redundancy bits, where K_{N} is the number of bits of the coded sequence, where R_{N} is the resultant code rate, where R₁ is the reference code rate and where δR is the predetermined threshold value.
